(19) United States
(12) Patent Application Publication
(10) Pub. No.: US 2025/0079439 A1
(43) Pub. Date: Mar. 6, 2025

(54) NEGATIVE ELECTRODE AND METHOD OF PRODUCING THE SAME, AND NON-AQUEOUS ELECTROLYTE SECONDARY BATTERY INCLUDING NEGATIVE ELECTRODE AND METHOD OF PRODUCING THE SAME

(71) Applicant: Prime Planet Energy & Solutions, Inc., Tokyo (JP)

(72) Inventor: Hajime TAMURA, Kobe-shi (JP)

(21) Appl. No.: 18/779,085

(22) Filed: Jul. 22, 2024

(30) Foreign Application Priority Data
Aug. 31, 2023 (JP) 2023-141137

(51) Int. Cl. H01M 4/133; H01M 4/02; H01M 4/1393; H01M 4/587; H01M 4/62

(52) U.S. Cl. CPC H01M 4/133; H01M 4/1393; H01M 4/587; H01M 4/622; H01M 4/625; H01M 2004/027

(57) ABSTRACT

A negative electrode for a non-aqueous electrolyte secondary battery has an active material layer including active material particles, carbon nanotubes, and a first binder. The active material particles include metal-based active material particles and carbon-based active material particles. The carbon nanotubes have a G/D ratio of 30 or more. An average length of the carbon nanotubes determined by analysis of a scanning transmission electron microscope image of the active material layer is 1.4 μm or more. The active material layer includes a mixed body in which the carbon nanotubes and the first binder are mixed. The mixed body includes a first mixed body formed on at least part of a surface of the active material particle and a second mixed body connecting a pair of the active material particles to each other.

### CROSS REFERENCE TO RELATED APPLICATIONS

This nonprovisional application is based on Japanese Patent Application No. 2023-141137 filed on Aug. 31, 2023, with the Japan Patent Office, the entire contents of which are hereby incorporated by reference.

### BACKGROUND OF THE INVENTION

### Field of the Invention

The present invention relates to a negative electrode and a method of producing the same, and a non-aqueous electrolyte secondary battery including a negative electrode and a method of producing the same.

### Description of the Background Art

A non-aqueous electrolyte secondary battery has a negative electrode that includes an active material layer. The active material layer may include active material particles such as graphite and SiOx, as well as fibrous carbon such as carbon nanotubes (see Japanese Patent Laying-Open No. 2021-99955, for example).

### SUMMARY OF THE INVENTION

Metal-based active material particles such as SiOx are less electrically conductive than graphite and undergo a great extent of expansion and shrinkage during charge and discharge of the secondary battery, so a conductive path formed between the metal-based active material particle and a neighboring active material particle can be easily deteriorated, likely to cause degradation of cycling performance of the secondary battery. Carbon nanotubes connect active material particles to each other and thereby can form good conductive paths, so they are used for reducing the above-mentioned deterioration of conductive paths. However, even when the active material layer includes carbon nanotubes, cycling performance of the secondary battery can sometimes degrade.

An object of the present disclosure is to provide a negative electrode that makes it possible to produce a secondary battery with excellent cycling performance and a method of producing the same, and a non-aqueous electrolyte secondary battery including a negative electrode and a method of producing the same.

[1] A negative electrode for a non-aqueous electrolyte secondary battery, comprising:
an active material layer including active material particles, carbon nanotubes, and a first binder, wherein
the active material particles include metal-based active material particles and carbon-based active material particles,
the carbon nanotubes have a G/D ratio of 30 or more,
an average length of the carbon nanotubes determined by analysis of a scanning transmission electron microscope image of the active material layer is 1.4 μm or more,
the active material layer includes a mixed body in which the carbon nanotubes and the first binder are mixed, and
the mixed body includes a first mixed body formed on at least part of a surface of the active material particle and a second mixed body connecting a pair of the active material particles to each other.

[2] The negative electrode according to [1], wherein a proportion of the carbon nanotubes present in the first mixed body and the second mixed body to all the carbon nanotubes present in the active material layer determined by analysis of the scanning transmission electron microscope image of the active material layer is 40% or more.

[3] The negative electrode according to [1] or [2], wherein the metal-based active material particles include particles of one or more types selected from the group consisting of Si, SiOx, and a Si—C composite.

[4] The negative electrode according to any one of [1] to [3], wherein the metal-based active material particles include particles of a Si—C composite.

[5] The negative electrode according to any one of [1] to [4], wherein the carbon nanotubes are single-walled carbon nanotubes.

[6] The negative electrode according to any one of [1] to [5], wherein the first binder is at least one of carboxymethylcellulose and polyacrylic acid.

[7] The negative electrode according to [6], wherein the active material layer includes a second binder, the second binder is different from the first binder, and the second binder includes styrene-butadiene rubber.

[8] A non-aqueous electrolyte secondary battery comprising the negative electrode according to any one of [1] to [7].

[9] A method of producing a negative electrode for a non-aqueous electrolyte secondary battery, the method comprising:
a first step to prepare a slurry; and
a second step to form an active material layer of the negative electrode by using the slurry, wherein
the slurry includes active material particles, a first binder, carbon nanotubes, and water,
the active material particles include metal-based active material particles and carbon-based active material particles, and
the carbon nanotubes have a G/D ratio of 30 or more.

[10] The method of producing a negative electrode according to [9], wherein the first step includes:
a step (1b) to mix and knead the active material particles, the first binder, the carbon nanotubes, and water at a solid content within a range of 60 to 65 weight % to obtain a mixed-kneaded body; and
a step (1c) to further add water to the mixed-kneaded body and mix and knead.

[11] The method of producing a negative electrode according to [10], wherein
the first binder is at least one of carboxymethylcellulose and polyacrylic acid,
the step (1c) includes a step to mix and knead the mixed-kneaded body and the water with a second binder, and
the second binder includes styrene-butadiene rubber.

[12] The method of producing a negative electrode according to [10] or [11], wherein
the first step includes, before the step (1b), a step (1a) to dry mix the active material particles and the first binder to obtain a mixture, and
the step (1b) involves mixing and kneading the mixture, the carbon nanotubes, and water.

[13] The method of producing a negative electrode according to any one of [10] to [12], wherein the mixing and kneading in the step (1b) is carried out by using a stirrer equipped with a stirring blade at a number of revolutions of the stirring blade of 60 rpm or less.

[14] The method of producing a negative electrode according to any one of [9] to [13], wherein a direct-current resistance of a 0.4-weight % aqueous dispersion of the carbon nanotubes at 25° C. is 2000Ω or less.

[15] The method of producing a negative electrode according to any one of [9] to [14], wherein the metal-based active material particles include particles of one or more types selected from the group consisting of Si, SiOx, and a Si—C composite.

[16] The method of producing a negative electrode according to any one of [9] to [15], wherein the first binder is at least one of carboxymethylcellulose and polyacrylic acid.

[17] A method of producing a non-aqueous electrolyte secondary battery, the method comprising a step to produce a negative electrode by the method of producing a negative electrode according to any one of [9] to [16].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a scanning transmission electron microscope image of an active material layer of a negative electrode according to an embodiment.

FIG. 2 is a scanning transmission electron microscope image of an active material layer of a negative electrode according to another embodiment.

FIG. 3 is a flowchart illustrating an example of a method of producing a negative electrode according to an embodiment.

### DESCRIPTION OF THE PREFERRED EMBODIMENTS

Herein, a numerical range such as “from x to y” includes the upper limit and the lower limit, unless otherwise specified. That is, “from x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### (Negative Electrode)

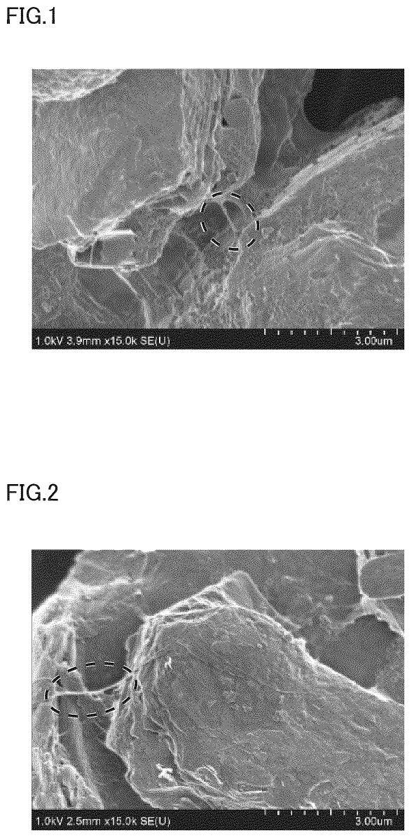

FIG. 1 is a scanning transmission electron microscope image (hereinafter also called “an SEM image”) of an active material layer of a negative electrode according to an embodiment, showing an active material layer obtained by carrying out a first step (1) of a method of producing a negative electrode described below. FIG. 2 is an SEM image of an active material layer of a negative electrode according to another embodiment, showing an active material layer obtained by carrying out a first step (2) of the below-described method of producing a negative electrode.

A negative electrode according to the present embodiment (hereinafter also called “the present negative electrode”) is a negative electrode for a non-aqueous electrolyte secondary battery (hereinafter also called “a secondary battery”), and includes an active material layer. The active material layer includes active material particles, carbon nanotubes (hereinafter also called “CNTs”), and a first binder. The active material particles include metal-based active material particles (hereinafter also called “metal-based particles”) and carbon-based active material particles (hereinafter also called “carbon-based particles”). The G/D ratio of the CNTs is 30 or more, and the average length of the CNTs obtained by analysis of an SEM image of the active material layer is 1.4 μm or more. The active material layer includes a mixed body in which the CNTs and the first binder are mixed. The mixed body includes a first mixed body formed on at least part of a surface of the active material particle, and a second mixed body connecting a pair of the active material particles to each other.

The present negative electrode may have the active material layer on its negative electrode current collector. The active material layer may be formed on only one side of the negative electrode current collector, or may be formed on both sides thereof. The negative electrode current collector is a metal foil that is made by using a copper material such as copper and copper alloy, for example.

The active material layer includes negative-electrode active material particles. The active material particles include metal-based particles and carbon-based particles, and may include active material particles other than metal-based particles and carbon-based particles. The total content of the carbon-based particles and the metal-based particles included in the active material particles may be from 90 to 100 weight %, or may be from 90 to 99 weight %, or may be from 92 to 95 weight % of all the active material particles. As for the ratio between the carbon-based particles and the metal-based particles in the active material particles, the weight ratio of (carbon-based particles):(metal-based particles) may be from 70:30 to 95:5, or may be from 80:20 to 92:8, or may be from 85:15 to 95:5.

When the active material layer is formed on both sides of the negative electrode current collector, the mass of the active material layer per unit area for both sides (the sum of both sides) may be from 150 to 250 g/m², or may be from 170 to 230 g/m², or may be from 180 to 210 g/m², for example. The mass per unit area of the negative electrode current collector per one side can be regarded as half the above-mentioned mass per unit area for both sides, for example. The thickness of the active material layer per one side may be from 90 to 200 μm, or may be from 100 to 180 μm, or may be from 120 to 150 μm, for example. The packing density of the active material layer can be calculated by the following equation, and may be from 1.3 to 1.9 g/cc, or may be from 1.4 to 1.8 g/cc, or may be from 1.5 to 1.7 g/cc, for example.

Packing density [g/cc]=(Mass of active material layer per unit area [g/m²])/(Thickness of active material layer [μm])

The metal-based particles include particles of a metallic element such as an elemental metal or a metal oxide including an element selected from the group consisting of silicon (Si), tin (Sn), antimony (Sb), bismuth (Bi), titanium (Ti), and germanium (Ge). Preferably, the metal-based particles include particles of one or more types selected from the group consisting of Si, SiOx (x=0.5 to 1.5), a Si—C composite (hereinafter also called “a SiC composite”), and Sn, or they are particles of one or more types selected from this group; more preferably, they are particles of one or more types selected from the group consisting of Si, SiOx, and a SiC composite. Further preferably, the metal-based particles are SiC composite particles. The SiC composite is, for example, a composite in which Si is dispersed in the carbon matrix.

Preferably, the carbon-based particles include particles of one or more types selected from the group consisting of carbon materials such as graphite, hard carbon, soft carbon, and amorphous-coated graphite, or they are particles of one or more types selected from this group; preferably, they include graphite particles, or they are graphite particles. The average particle size, D50, of the graphite particles may be from 5 to 20 μm, or may be from 8 to 10 μm, or may be from 10 to 15 μm. The average particle size D50 herein refers to the particle size in volume-based particle size distribution at which cumulative frequency of particle sizes accumulated from the small size side reaches 50%. The volume-based particle size distribution can be measured with a laser-diffraction particle size distribution analyzer. The specific surface area (BET) of the graphite particles may be from 1.0 to 3.0 m²/g, or may be from 1.2 to 2.5 m²/g. The specific surface area can be calculated by a BET multi-point method in an absorption isotherm obtained by measurement by a gas adsorption method with the use of a fully-automatic specific surface area meter and/or the like.

The CNTs may be single-walled carbon nanotubes (hereinafter also called “SWCNTs”), or may be multi-walled carbon nanotubes such as double-walled carbon nanotubes (DWCNTs). From the viewpoint of obtaining CNTs with less defects in the CNT structure and with greater G/D ratio, the CNTs are preferably SWCNTs.

The G/D ratio of the CNTs is 30 or more, and may be 40 or more, or may be 50 or more, or may be from 30 to 200, or may be from 40 to 180, or may be from 50 to 150. The G/D ratio is a value determined by Raman spectrometry. In the Raman spectrum of the CNTs, the Raman shift at or near 1590 cm⁻¹ is called a G band which is attributable to graphite, and the Raman shift at or near 1350 cm⁻¹ is called a D band which is attributable to defects of amorphous carbon and/or graphite. Hence, it can be said that the greater the G/D ratio, the higher the crystallinity and strength of the CNTs. When a slurry that includes the CNTs, the active material particles, and a first binder is used as described below for forming the active material layer, a strong shearing force can be sometimes applied to these components while they are mixed and kneaded, for the purpose of enhancing dispersibility of the CNTs. By using CNTs having a G/D ratio within the above-mentioned range, it is possible to prevent the CNTs from being cut into short pieces, or otherwise becoming shorter, at the time of mixing and kneading the components. This enables formation of good conductive paths between the active material particles, enhancing cycling performance of the secondary battery. The G/D ratio herein is a value calculated by defining G as the intensity of the highest peak appearing within the range of 1550 to 1650 cm⁻¹ in the Raman spectrum of the CNTs and defining D as the intensity of the highest peak appearing within the range of 1300 to 1400 cm⁻¹. The G/D ratio of the CNTs can be determined by the procedure described below in Examples.

The average length of the CNTs in the active material layer is 1.4 μm or more, or may be 1.5 μm or more, or may be 1.6 μm or more, or may be 1.7 μm or more, or may be 2.0 μm or more, or may be 2.5 μm or more. The average length of the CNTs may be from 1.4 to 5.0 μm, or may be from 1.5 to 3.0 μm, or may be from 2.0 to 2.5 μm. The average length of the CNTs can be determined by analysis of an SEM image as described below in Examples. It is conceivable that when CNTs with the above-mentioned average length are present in the active material layer, good conductive paths can be formed between the active material particles and cycling performance of the secondary battery can be enhanced.

The direct-current resistance of the CNTs in the active material layer, when it is in the form of a 0.4-weight % aqueous dispersion, at 25° C. may fall within the range that is described below in the section describing a method of producing a negative electrode.

The content of the CNTs in the active material layer may be from 0.01 to 1 part by weight, or may be from 0.05 to 0.1 parts by weight, or may be from 0.1 to 0.5 parts by weight, relative to 100 parts by weight of the active material particles.

The first binder may be one or more types selected from the group consisting of cellulose-based binders such as carboxymethylcellulose (hereinafter also called “CMC”), methylcellulose (hereinafter also called “MC”), and hydroxypropylcellulose and polyacrylic acid (hereinafter also called “PAA”). Preferably, the first binder includes at least one of CMC and PAA, more preferably includes CMC and PAA. Each of CMC, MC, and PAA may be either in acid form or in salt form, preferably in salt form. Examples of the salt include salts of an alkali metal such as potassium and sodium.

The content of the first binder in the active material layer may be from 0.5 to 5 parts by weight, or may be from 1 to 4 parts by weight, or may be from 2 to 3 parts by weight, relative to 100 parts by weight of the active material particles. When two or more first binders are used, the content of the first binder refers to the total amount of them.

The mixed body refers to a mixture of the CNTs and the first binder in which the CNTs and the first binder are entangled with each other. A state where CNTs are adhered to the surface of a layer formed of the first binder is not encompassed by the mixed body. The mixed body includes a first mixed body and a second mixed body. In the active material layer, the first mixed body and the second mixed body may be connected to each other to form one component, or may not form one component, or, alternatively, there may be a first mixed body that forms one component with a second mixed body as well as a first mixed body that does not form one component with a second mixed body. Each end of the second mixed body, which connects a pair of active material particles to each other, may be located on the surface of the corresponding active material particle. In this case, in the present specification, a portion of the second mixed body that is in contact with an active material particle and that also has the same diameter as the diameter of the bridge-like connecting portion (a portion that is present between two active material particles to connect them to each other) is included in the second mixed body but not included in the first mixed body, while the other portion in contact with an active material particle is included in the first mixed body but not included in the second mixed body.

The first mixed body can be formed in such a manner that it is in direct contact with the surface of an active material particle. The first mixed body is simply required to be formed on at least part of the surface of an active material particle, and, for example, it may be formed in the shape of spots on the surface of an active material particle or may be formed to cover the entire surface of an active material particle. As compared to the case where a CNT is placed on the surface of a layer of the first binder formed on the surface of an active material particle, in the case where the first mixed body is present, a point of electric contact between the active material particle and the CNT is more likely to be ensured, which can reduce output and input resistances of a secondary battery in which the present negative electrode is used.

As seen in the broken-line circles in FIG. 1 and FIG. 2, the second mixed body is formed to connect two active material particles to each other. Both ends of the second mixed body can be formed in such a manner that it is in direct contact with the surface of the two active material particles, respectively. Because the second mixed body enables formation of conductive paths between active material particles, a secondary battery including the present negative electrode can have excellent cycling performance.

The active material layer that includes the first mixed body and the second mixed body may be obtained by adjusting conditions during preparation of a slurry that is to be used for forming the active material layer (to be described below), such as the timing to mix the CNTs as well as the solid concentration at the time of mixing the CNTs.

In addition to the CNTs which are present in the mixed body, CNTs that are not present in the mixed body (in other words, not mixed with the first binder) may also be included in the active material layer. The proportion of the CNTs present in the first mixed body and the second mixed body to all the CNTs in the active material layer (hereinafter also called “the CNT proportion”) is preferably 40% or more, and more preferably, it may be 45% or more, or may be 50% or more. Preferably, the CNT proportion is from 40 to 90%, and it may be from 45 to 80%, or may be from 50 to 70%. When the CNT proportion falls within the above-mentioned range, points of electric contact between the active material particles and the CNTs tend to be ensured, which can further reduce output and input resistances of a secondary battery in which the present negative electrode is used. The CNT proportion can be determined by analysis of an SEM image of the active material layer, as described below in Examples.

The proportion of the CNTs may be adjusted to the above-mentioned proportion by adjusting conditions during preparation of a slurry that is to be used for forming the active material layer, such as the timing to mix the CNTs as well as the solid concentration at the time of mixing the CNTs. In an active material layer obtained by carrying out a first step (1) described below (FIG. 1), the CNT proportion can be easily adjusted to fall within the above-mentioned range, and entanglement between the CNTs and the first binder in the second mixed body tends to be great. In contrast, in an active material layer obtained by carrying out a first step (2) described below (FIG. 2), the CNT proportion cannot be easily adjusted to fall within the above-mentioned range, and entanglement between the CNTs and the first binder in the second mixed body tends to be less.

In addition to the active material particles, the CNTs, and the first binder, the active material layer may include a second binder which is not the first binder, a conductive material other than CNTs, and/or the like. When the first binder includes at least one of CMC and PAA, or when it is at least one of CMC and PAA, the second binder may include at least one of styrene-butadiene rubber (SBR) and polyvinyl alcohol (PVA), and, preferably, it includes SBR. Examples of the conductive material other than CNTs include carbon materials such as carbon black (for example, acetylene black, Ketjenblack), coke, activated carbon, and the like.

### (Method of Producing Negative Electrode)

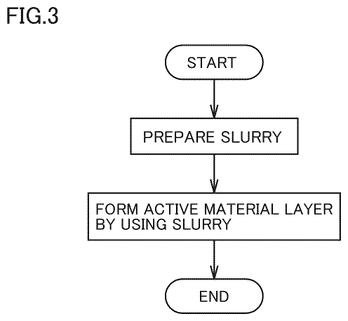

FIG. 3 is a flowchart illustrating a method of producing a negative electrode according to an embodiment. The method of producing a negative electrode according to the present embodiment is capable of producing a negative electrode for a secondary battery, and it is also capable of producing the present negative electrode. The method of producing a negative electrode includes a first step to prepare a slurry, and a second step to form an active material layer of the negative electrode by using the slurry (FIG. 3). The slurry includes active material particles, a first binder, CNTs, and water. The active material particles include metal-based particles and carbon-based particles, and the G/D ratio of the CNTs is 30 or more.

The slurry prepared in the first step includes the active material particles, the first binder, the CNTs, and water. The solid content of the slurry may be from 35 to 55 weight %, or may be from 40 to 50 weight %, or may be from 43 to 48 weight %. As each of the metal-based particles and the carbon-based particles, the above-mentioned material may be used. As the first binder, the above-mentioned material may be used.

As the CNTs, the above-mentioned material may be used, preferably SWCNTs. The G/D ratio of the CNTs may be set to fall within the above-mentioned range. The direct-current resistance of a 0.4-weight % aqueous dispersion of the CNTs at 25° C. is preferably 2000Ω or less, or may be 1900Ω or less, or may be 1800Ω or less, or may be 1700Ω or less, or may be from 500 to 2000Ω, or may be from 700 to 1900Ω, or may be from 1000 to 1800Ω, or may be from 1000 to 1700Ω. CNTs having a direct-current resistance within the above-mentioned range have excellent electrical conductivity, and thereby can form good conductive paths between the active material particles of the active material layer. The direct-current resistance can be measured by the procedure described below in Examples.

The slurry may further include a second binder, and may include a conductive material other than CNTs. As each of the second binder and the conductive material, the above-mentioned material may be used.

The first step may be either a first step (1) or a first step (2) described below. When the first step is either the first step (1) or the first step (2), a negative electrode having a G/D ratio of 30 or more, having an average length of CNTs in the active material layer of 1.4 μm or more, and having the first mixed body and the second mixed body in the active material layer tends to be obtained. From the viewpoint of obtaining an active material layer having the above-mentioned CNT proportion, the first step is preferably the first step (1).

The second step is a step to form the active material layer by using the slurry prepared in the first step. The second step can include a step to apply the slurry to a negative electrode current collector to form a coating layer and dry the coating layer, and it may further include a step to compress the dried coating layer. As the negative electrode current collector, the above-mentioned material may be used.

The first step (1) may include a step (1b) to mix and knead the active material particles, the first binder, the CNTs, and water at a solid content within the range of 60 to 65 weight % to obtain a first mixed-kneaded body (a mixed-kneaded body), and a step (1c) to further add water to the first mixed-kneaded body and mix and knead. The step (1c) is carried out after the step (1b) is carried out to mix and knead the active material particles, the first binder, and the CNTs at a relatively great solid content. In this case, entanglement between the first binder and the CNTs tends to be great, making it easier to adjust the proportion of the CNTs present in the first mixed body to fall within the above-mentioned range and making it easier to ensure points of electric contact between the active material particles and the CNTs. Also, entanglement between the CNTs and the first binder in the second mixed body tends to be great. Accordingly, when a negative electrode produced by a production method that includes the first step (1) is used, a secondary battery with excellent cycling performance and with reduced output and input resistances tends to be obtained.

The solid content in the step (1b) (the solid content of the first mixed-kneaded body) is preferably from 60 to 65 weight %, and it may be from 61 to 65 weight %, or may be from 62 to 65 weight %, or may be from 63 to 64 weight %. When the solid content in the step (1b) falls within the above-mentioned range, the CNT proportion can be easily adjusted to fall within the above-mentioned range, and entanglement between the CNTs and the first binder in the second mixed body tends to be great.

The first step (1) may include, before the step (1b), a step (1a) to dry mix the active material particles and the first binder to obtain a mixture. In the case where the first step (1) includes the step (1a), the step (1b) may perform mixing and kneading the mixture, the CNTs, and water to form the first mixed-kneaded body. The first step (1) may include a step (1c) to further add water to the first mixed-kneaded body and mix and knead. The step (1c) may include a step to mix and knead a second binder with the first mixed-kneaded body and water. In this case, the timing to mix and knead the first mixed-kneaded body, the second binder, and water in the step (1c) is not particularly limited, and they may be mixed and kneaded all at once, or, alternatively, the first mixed-kneaded body and water may be firstly mixed and kneaded followed by addition of the second binder with mixing and kneading.

The first step (1) may be carried out by using a stirrer equipped with a stirring blade. The number of revolutions of the stirring blade in each step included in the first step (1) is not particularly limited. The number of revolutions of the stirring blade in the step (1b) may be 60 rpm or less, or may be 50 rpm or less, or may be 40 rpm, or may be from 10 to 60 rpm, or may be from 20 to 50 rpm, or may be from 30 to 40 rpm. In the production method according to the present embodiment, CNTs having a great G/D ratio are used, and, thereby, even when the mixing and kneading in the step (1b) is carried out at the above-mentioned number of revolutions, CNTs are less likely to be cut into pieces. This enables formation of good conductive paths in the active material layer, enhancing cycling performance of the secondary battery. The duration of mixing and kneading in the step (1b) may be from 10 to 200 min, or may be from 70 to 150 min, or may be from 80 to 120 min.

The number of revolutions of the stirring blade in the step (1c) may be 50 rpm or less, or may be 40 rpm or less, or may be 30 rpm or less, or may be from 5 to 50 rpm, or may be from 10 to 40 rpm, or may be from 20 to 30 rpm. The duration of mixing and kneading in the step (1c) may be from 10 to 180 min, or may be from 20 to 150 min, or may be from 30 to 120 min, for example.

The first step of the method of producing a negative electrode may be carried out not by the above-mentioned first step (1) but by the first step (2), which is to be described below. The first step (2) may include a step (2b) to mix and knead the active material particles, the first binder, and water to obtain a second mixed-kneaded body, a step (2c) to mix and knead the second mixed-kneaded body and the CNTs to obtain a third mixed-kneaded body, and a step (2d) to add water to the third mixed-kneaded body and mix and knead. In the first step (2), CNTs are added and mixed and kneaded after the active material particles and the first binder are mixed and kneaded, so the CNTs can be dispersed in a short time. As a result, as compared with production in the first step (1), the first binder is more likely to become adhered to the surface of the active material particles than to be mixed with the CNTs, and the CNTs tend to become adhered to the first binder that is present on the surface of the active material particles. Consequently, the proportion of the CNTs present in the first mixed body and the second mixed body cannot be easily adjusted to fall within the above-mentioned range, and entanglement of the CNTs with the first binder in the first mixed body and the second mixed body tends to be less. Consequently, the output and input resistances of the negative electrode produced by the first step (2) tends to be great as compared to that of the negative electrode produced by the first step (1).

The solid content in the step (2b) (the solid content of the second mixed-kneaded body) is preferably from 60 to 65 weight %, and it may be from 61 to 65 weight %, or may be from 62 to 65 weight %, or may be from 63 to 64 weight %.

The first step (2) may include, before the step (2b), a step (2a) to dry mix the active material particles and the first binder to obtain a mixture. In the case where the first step (2) includes the step (2a), the step (2b) may perform mixing and kneading the mixture and water to form the second mixed-kneaded body.

The solid content in the step (2c) (the solid content of the third mixed-kneaded body) is more than 55 weight % and less than 60 weight %, for example, or from 56 to 59 weight %, and it may be from 57 to 58 weight %.

The step (2d) may include a step to mix and knead the third mixed-kneaded body and water with the second binder. The timing to mix and knead the third mixed-kneaded body, the second binder, and water in the step (2d) is not particularly limited, and they may be mixed and kneaded all at once, or, alternatively, the third mixed-kneaded body and water may be firstly mixed and kneaded followed by addition of the second binder with mixing and kneading.

The first step (2) may be carried out by using a stirrer equipped with a stirring blade. The number of revolutions of the stirring blade in each step included in the first step (2) is not particularly limited. For example, the number of revolutions of the stirring blade in the step (2b) may be from 10 to 65 rpm, or may be from 20 to 60 rpm, or may be from 30 to 55 rpm. The duration of mixing and kneading in the step (2b) may be from 10 to 200 min, for example, or may be from 70 to 150 min, or may be from 80 to 120 min.

The number of revolutions of the stirring blade in the step (2c) may be from 20 to 65 rpm, or may be from 30 to 60 rpm, or may be from 40 to 55 rpm. The duration of mixing and kneading in the step (2c) may be from 5 to 60 min, for example, or may be from 10 to 30 min, or may be from 10 to 20 min.

The number of revolutions of the stirring blade in the step (2d) may be from 5 to 50 rpm, or may be from 10 to 40 rpm, or may be from 20 to 30 rpm. The duration of mixing and kneading in the step (2d) may be from 10 to 90 min, for example, or may be from 15 to 60 min, or may be from 30 to 45 min.

### (Non-Aqueous Electrolyte Secondary Battery)

A non-aqueous electrolyte secondary battery according to the present embodiment (hereinafter also called “the present battery”) includes the present negative electrode, and, usually, it includes an electrode assembly that includes the present negative electrode, and a non-aqueous electrolyte solution. The present battery may have a battery case for accommodating the electrode assembly and the non-aqueous electrolyte solution. The battery case can include an exterior package having an opening, as well as a sealing plate for sealing the opening. Each of the exterior package and the sealing plate is preferably made of metal, can be formed by using aluminum, aluminum alloy, iron, iron alloy, or the like, and, for example, can be formed by using an aluminum laminated film. Between the electrode assembly and the exterior package, a resin sheet may be provided as an electrode holder.

The electrode assembly may include the present negative electrode, a positive electrode, and a separator. In the electrode assembly, the active material layer of the present negative electrode faces a positive electrode active material layer of the positive electrode, with the separator interposed therebetween. The electrode assembly may be a stack-type one that is formed by stacking the present negative electrode, the positive electrode, and the separator, or may be a wound-type one that is formed by stacking the present negative electrode, the positive electrode, and the separator and winding the resulting stack.

The positive electrode usually has a positive electrode current collector and a positive electrode active material layer, and, for example, the positive electrode current collector is a metal foil that is made by using an aluminum material such as aluminum and aluminum alloy. The positive electrode active material layer includes positive electrode active material particles, and may further include a conductive material, a binder, and the like. Examples of the positive electrode active material particles include particles of a lithium transition metal oxide of layered type, spinel type, or the like (for example, LiNiCoMnO₂, LiNiO₂, LiCoO₂, LiFeO₂, LiMn₂O₄, LiNi_{0.5}Mn_{1.5}O₄, LiCrMnO₄, LiFePO₄, LiNi_{1/3}Co_{1/3}Mn_{1/3}O₂). The lithium transition metal oxide may be lithium-nickel-cobalt-manganese composite oxide (NCM). Examples of the conductive material include carbon materials such as fibrous carbon (CNTs (SWCNTs, DWCNTs)), carbon black (for example, acetylene black, Ketjenblack), coke, activated carbon, and the like. Examples of the binder include polyvinylidene difluoride (PVdF), polytetrafluoroethylene (PTFE), SBR, and the like.

The separator has a base material, and may have a functional layer on at least one side of the base material. The base material can be a porous sheet such as a film and a nonwoven fabric made of a resin such as polyethylene, polypropylene, polyester, cellulose, and/or polyamide. The base material may have a monolayer structure or a multilayer structure. The functional layer may be, for example, either an adhesive layer or a heat-resistant layer, or both. The adhesive layer can be formed with an adhesive agent, for example. The heat-resistant layer can include a filler and a binder, for example.

The non-aqueous electrolyte solution is preferably obtained by adding a supporting salt to a non-aqueous solvent such as an organic solvent. Examples of the supporting salt include LiPF₆, LiBF₄, LiClO₄, LiFSO₃, LiBOB (lithium bis(oxalato)borate), and the like. The non-aqueous electrolyte solution may include one, two, or more supporting salts, among these. Examples of the non-aqueous solvent include ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution can include one, two, or more non-aqueous solvents, among these.

### (Method of Producing Non-Aqueous Electrolyte Secondary Battery)

The method of producing the present battery includes a step to produce a negative electrode by the method of producing the present negative electrode. The method of producing the present battery may further include a step to obtain an electrode assembly by using the present negative electrode, a positive electrode, and a separator, and a step to place the electrode assembly and a non-aqueous electrolyte solution in a battery case.

### EXAMPLES

In the following, the present disclosure will be described in further detail by way of Examples and Comparative Examples.

### Example 1

### (Production of Negative Electrode: Production by First Step (1))

Graphite particles were used as carbon-based particles, and particles of a Si—C composite (SiC composite particles) were used as metal-based particles. The average particle size, D50, of the graphite particles was 17 μm, and the specific surface area (BET) of the graphite particles was 2.2 m²/g. CNTs had the G/D ratio and the direct-current resistance in a state of a 0.4-weight % aqueous dispersion as specified in Table 1. A slurry (1) was prepared by the procedure described below, with the use of a stirrer (manufactured by PRIMIX Corporation, HIVIS MIX 2P-1).

Firstly, the carbon-based particles, the metal-based particles, and CMC and PAA as first binders were dry mixed to obtain a mixture (a step (1a)). Then, CNTs (water-soluble paste with a solid content of 1 weight %) and water were added to the resulting mixture to achieve a solid content of 64 weight %, and mixing and kneading were performed for 90 min at a number of revolutions of the stirrer of 50 rpm to obtain a first mixed-kneaded body (a step (1b)). Water was further added to the resulting first mixed-kneaded body and mixing and kneading were performed for 30 min at a number of revolutions of the stirrer of 30 rpm, followed by addition of SBR as a second binder and 5 min of mixing and kneading at a number of revolutions of the stirrer of 30 rpm (a step (1c)), to obtain a slurry (1) having a solid content of 46 weight %. The blending ratio for the slurry (1) was (graphite particles):(SiC composite particles):CNT:CMC:PAA:SBR=91:9:0.05:1:1:1 (weight ratio).

The slurry (1) obtained in the above-mentioned manner was applied to both sides of a copper foil having a thickness of 8 μm serving as a negative electrode current collector, and dried and compressed to obtain a negative electrode (1). The mass of the active material layer of the negative electrode (1) per unit area (the total mass per unit area for both sides) was 195 g/m², the thickness of the active material layer (per one side) was 130 μm, and the packing density of the active material layer was 1.52 g/cc. The active material layer of the negative electrode (1) included a first mixed body and a second mixed body.

### (Production of Positive Electrode)

Lithium-nickel-cobalt-manganese composite oxide (NCM) as positive electrode active material particles, acetylene black (AB) as a conductive material, and polyvinylidene difluoride (PVdF) as a binder were used in a weight ratio of (positive electrode active material particles):AB:PVdF=100:1:1, and they were mixed with N-methylpyrrolidone (NMP) as a solvent to obtain a positive electrode composite material slurry. The resulting positive electrode composite material slurry was applied to an aluminum foil having a thickness of 15 μm serving as a positive electrode current collector, and dried and compressed to obtain a positive electrode.

### (Production of Non-Aqueous Electrolyte Secondary Battery)

A lead was attached to each of the negative electrode and the positive electrode obtained in the above-mentioned manner, and the negative electrode and the positive electrode were stacked on top of one another with a separator interposed therebetween, to obtain an electrode assembly. The resulting electrode assembly was inserted into an exterior package made of an aluminum-laminated sheet, and a non-aqueous electrolyte solution was injected, followed by sealing the opening of the exterior package to obtain a test cell (a laminated cell) (1). The non-aqueous electrolyte solution was a mixed solvent that contained ethylene carbonate (EC), ethyl methyl carbonate (EMC), and dimethyl carbonate (DMC) in a volume ratio of EC:EMC:DMC=20:40:40, in which LiPF₆ as a lithium salt was dissolved in a concentration of 1 mol/L.

### Example 2

### (Production of Negative Electrode: Production by First Step (2))

By the procedure described below, a slurry (2) was prepared and a negative electrode (2) was obtained. The carbon-based particles, the metal-based particles, the CNTs, the first binder, the second binder, and the stirrer used in the present example were the same as those used in the production of negative electrode in Example 1.

Firstly, the carbon-based particles (graphite particles), the metal-based particles (SiC composite particles), and the first binder (CMC and PAA) were dry mixed to obtain a mixture (a step (2a)). Subsequently, water was added to the resulting mixture to achieve a solid content of 64 weight %, and mixing and kneading were performed for 90 min at a number of revolutions of the stirrer of 50 rpm to obtain a second mixed-kneaded body (a step (2b)). Then, CNTs (water-soluble paste with a solid content of 1 weight %) were added to the resulting second mixed-kneaded body to achieve a solid content of 54 weight %, and mixing and kneading were performed for 15 min at a number of revolutions of the stirrer of 50 rpm to obtain a third mixed-kneaded body (a step (2c)). Water was further added to the resulting third mixed-kneaded body and mixing and kneading were performed for 30 min at a number of revolutions of the stirrer of 30 rpm, followed by addition of the second binder (SBR) and 5 min of mixing and kneading at a number of revolutions of the stirrer of 30 rpm (a step (2d)), to obtain a slurry (2) having a solid content of 46 weight %. By the same procedure as employed for the production of negative electrode in Example 1 except that the slurry (2) was used instead of the slurry (1), a negative electrode (2) was obtained. The active material layer of the negative electrode (2) included a first mixed body and a second mixed body.

### (Production of Non-Aqueous Electrolyte Secondary Battery)

A test cell (2) was obtained by the same procedure as employed for the production of non-aqueous electrolyte secondary battery in Example 1 except that the negative electrode (2) was used instead of the negative electrode (1).

### Comparative Example 1

A negative electrode (c1) and a test cell (c1) were obtained by the same procedure as described for Example 1 except that, instead of the CNTs used in Example 1, CNTs having the G/D ratio and the direct-current resistance in a state of a 0.4-weight % aqueous dispersion as specified in Table 1 were used.

### Comparative Example 2

A negative electrode (c2) and a test cell (c2) were obtained by the same procedure as described for Example 2 except that, instead of the CNTs used in Example 2, CNTs having the G/D ratio and the direct-current resistance in a state of a 0.4-weight % aqueous dispersion as specified in Table 1 were used.

### [Determination of G/D Ratio of CNTs]

A CNT dispersion was placed on a cover glass, and to a region thereof having a diameter of 300 μm, laser light having an excitation wavelength of 532 nm was applied with the use of a Raman microscope (manufactured by HORIBA) to obtain a Raman spectrum. In the Raman spectrum thus obtained, the G/D ratio was calculated, with G defined as the intensity of the highest peak within the range of 1550 to 1650 cm⁻¹ and D defined as the intensity of the highest peak within the range of 1300 to 1400 cm⁻¹. Results are given in Table 1.

### [Measurement of Direct-Current Resistance of CNTs]

A 0.4-weight % aqueous dispersion of the CNTs (solid content, 1 weight %) was injected into a measurement vessel of an LCR meter and test fixture (manufactured by HIOKI E.E.), and left to stand for 24 hours. Subsequently, the alternating-current impedance was measured at 25° C. at a measurement frequency from 4 Hz to 10 MHz, and with the use of a specifically-designed analysis system, the direct-current resistance (DCR) was measured. Results are given in Table 1.

### [Determination of Average Length of CNTs and CNT Proportion]

### (Obtaining SEM Image)

With the use of a scanning transmission electron microscope (SEM, manufactured by Hitachi High-Tech), at an accelerating voltage of 1 kV, the surface of the active material layer of the negative electrode was examined in an SEM image having a field of view of 9×7 μm.

### (Determination of Average Length of CNTs)

Imaging software was used to mark CNTs in the SEM image in the form of lines to measure the perimeter of each line, and half the value was regarded as the length of the CNT. Because a CNT has a very long length as compared to the diameter in terms of the aspect ratio, contribution of the width of the line to the perimeter is negligible. For all the CNTs in the SEM image, the lengths of the CNTs were determined, and the average value of them was regarded as the average length of the CNTs. Results are given in Table 1. For Comparative Examples 1 and 2, the average length of the CNTs is not given; because the CNTs used in Comparative Examples 1 and 2 had a small G/D ratio, the CNTs could have probably become too short during slurry preparation to be found in the SEM image.

### (Determination of CNT Proportion)

For all the CNTs in the SEM image obtained in the above-mentioned manner, the proportion [%] of CNTs present in the first mixed body and the second mixed body (CNT proportion [%]) was calculated by the below equation. Results are given in Table 1.

CNT proportion [%]=((Area of CNTs present in first mixed body and second mixed body in SEM image)/(Area of all CNTs in SEM image))×100

### [Evaluation of Initial Efficiency]

In an environment at 25° C., the test cell was charged and discharged for one cycle, which consisted of charging at a value of current of 0.05 C to reach 4.2 V (CC charging) and then discharging at a value of current of 0.05 C to reach 2.5 V (CC discharging). From the discharged capacity at the first cycle and the charged capacity at the first cycle, initial efficiency [%] was calculated by the following equation. Results are given in Table 1.

Initial efficiency [%]=((Discharged capacity at the first cycle)/(Charged capacity at the first cycle))×100

### [Evaluation of Output and Input Resistances]

### (Calculation of Input Resistance)

In an environment at 25° C., the test cell was charged at a value of current of 0.33 C to reach a charging ratio (SOC) of 50%, and then charged by constant-current·constant-voltage charging (CCCV) at a value of current of 0.33 C to reach a charging ratio of 50%, followed by 30 min of rest. Subsequently, charging was performed at a value of current of 0.2 C for 10 s, and the IV (current and voltage) at this time was measured to calculate the input resistance. Results are given in Table 1.

### (Calculation of Output Resistance)

In an environment at 25° C., the test cell was charged at a value of current of 0.33 C to reach a charging ratio (SOC) of 50%, and then charged by constant-current-constant-voltage charging (CCCV) at a value of current of 0.33 C to reach a charging ratio of 50%, followed by 30 min of rest. Subsequently, discharging was performed at a value of current of 0.2 C for 10 s, and the IV (current and voltage) at this time was measured to calculate the output resistance. Results are given in Table 1.

### [Evaluation of Cycling Performance]

In an environment at 25° C., the test cell was charged and discharged for multiple cycles, where one cycle consisted of charging by constant-current·constant-voltage charging (CCCV) at a value of current of 0.33 C to reach 4.2 V and then discharging at a value of current of 0.33 C to reach 2.5 V (CC discharging). By the following equation, the discharged capacity at the 100th cycle relative to the discharged capacity at the first cycle was calculated, which was regarded as capacity retention [%]. Results are given in Table 1.

Capacity retention [%]=((Discharged capacity at the 100th cycle)/(Discharged capacity at the first cycle))×100

TABLE 1

| | | | Comp. | Comp. |
|---|---|---|---|---|
| | Ex. 1 | Ex. 2 | Ex. 1 | Ex. 2 |
| Negative electrode | (1) | (2) | (c1) | (c2) |
| Slurry | (1) | (2) | (c1) | (c2) |
| First step | (1) | (2) | (1) | (2) |
| CNTs | | | | |
| G/D ratio | 69.19 | 69.19 | 1.30 | 1.30 |
| Direct-current | 1645 | 1645 | 2888 | 2888 |
| resistance [Ω] | | | | |
| Average length [μm] | 1.57 | 2.63 | — | — |
| CNT proportion*¹ [%] | 48 | 19.6 | — | — |
| Test cell | (1) | (2) | (c1) | (c2) |
| Initial efficiency [%] | 99.6 | 99.6 | 99.7 | 99.7 |
| Input resistance [Ω] | 0.091 | 0.096 | 0.101 | 0.103 |
| Output resistance [Ω] | 0.093 | 0.097 | 0.103 | 0.105 |
| Capacity retention [%] | 96.25 | 96.42 | 82.83 | 83.67 |

*¹The proportion of CNTs present in the first mixed body and the second mixed body in the SEM image

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A negative electrode for a non-aqueous electrolyte secondary battery, comprising:
an active material layer including active material particles, carbon nanotubes, and a first binder, wherein
the active material particles include metal-based active material particles and carbon-based active material particles,
the carbon nanotubes have a G/D ratio of 30 or more,
an average length of the carbon nanotubes determined by analysis of a scanning transmission electron microscope image of the active material layer is 1.4 μm or more,
the active material layer includes a mixed body in which the carbon nanotubes and the first binder are mixed, and
the mixed body includes a first mixed body formed on at least part of a surface of the active material particle and a second mixed body connecting a pair of the active material particles to each other.

2. The negative electrode according to claim 1, wherein a proportion of the carbon nanotubes present in the first mixed body and the second mixed body to all the carbon nanotubes present in the active material layer determined by analysis of the scanning transmission electron microscope image of the active material layer is 40% or more.

3. The negative electrode according to claim 1, wherein the metal-based active material particles include particles of one or more types selected from the group consisting of Si, SiOx, and a Si—C composite.

4. The negative electrode according to claim 1, wherein the metal-based active material particles include particles of a Si—C composite.

5. The negative electrode according to claim 1, wherein the carbon nanotubes are single-walled carbon nanotubes.

6. The negative electrode according to claim 1, wherein the first binder is at least one of carboxymethylcellulose and polyacrylic acid.

7. The negative electrode according to claim 6, wherein
the active material layer includes a second binder, the second binder is different from the first binder, and
the second binder includes styrene-butadiene rubber.

8. A non-aqueous electrolyte secondary battery comprising the negative electrode according to claim 1.

9. A method of producing a negative electrode for a non-aqueous electrolyte secondary battery, the method comprising:
a first step to prepare a slurry; and
a second step to form an active material layer of the negative electrode by using the slurry, wherein
the slurry includes active material particles, a first binder, carbon nanotubes, and water,
the active material particles include metal-based active material particles and carbon-based active material particles, and
the carbon nanotubes have a G/D ratio of 30 or more.

10. The method of producing a negative electrode according to claim 9, wherein the first step includes:
a step (1b) to mix and knead the active material particles, the first binder, the carbon nanotubes, and water at a solid content within a range of 60 to 65 weight % to obtain a mixed-kneaded body; and
a step (1c) to further add water to the mixed-kneaded body and mix and knead.

11. The method of producing a negative electrode according to claim 10, wherein
the first binder is at least one of carboxymethylcellulose and polyacrylic acid,
the step (1c) includes a step to mix and knead the mixed-kneaded body and the water with a second binder, and
the second binder includes styrene-butadiene rubber.

12. The method of producing a negative electrode according to claim 10, wherein
the first step includes, before the step (1b), a step (1a) to dry mix the active material particles and the first binder to obtain a mixture, and
the step (1b) involves mixing and kneading the mixture, the carbon nanotubes, and water.

13. The method of producing a negative electrode according to claim 12, wherein the mixing and kneading in the step (1b) is carried out by using a stirrer equipped with a stirring blade at a number of revolutions of the stirring blade of 60 rpm or less.

14. The method of producing a negative electrode according to claim 9, wherein a direct-current resistance of a 0.4-weight % aqueous dispersion of the carbon nanotubes at 25° C. is 2000Ω or less.

15. The method of producing a negative electrode according to claim 9, wherein the metal-based active material particles include particles of one or more types selected from the group consisting of Si, SiOx, and a Si—C composite.

16. The method of producing a negative electrode according to claim 9, wherein the first binder is at least one of carboxymethylcellulose and polyacrylic acid.

17. A method of producing a non-aqueous electrolyte secondary battery, the method comprising a step to produce a negative electrode by the method of producing a negative electrode according to claim 9.
